(19) United States
(12) Patent Application Publication
(10) Pub. No.: US 2020/0195695 A1
(43) Pub. Date: Jun. 18, 2020

(54) SYSTEMS AND DEVICES FOR CONTROLLING USE OF A CONSUMABLE ITEM WITH USER DEVICES, AND RELATED SYSTEMS, METHODS, AND DEVICES

(71) Applicant: Microchip Technology Incorporated, Chandler, AZ (US)

(72) Inventor: Nuri Ruhi Dagdeviren, Sausalito, CA (US)

(21) Appl. No.: 16/442,205

(22) Filed: Jun. 14, 2019

Related U.S. Application Data
(60) Provisional application No. 62/781,357, filed on Dec. 18, 2018.

(51) Int. Cl. H04L 29/06; H04L 9/08; H04L 29/08; H04W 60/00

(52) U.S. Cl. CPC H04L 65/1073; H04L 63/12; H04W 60/00; H04L 67/125; H04L 9/0866

(57) ABSTRACT

Systems, methods and devices described herein relate, generally, to controlling use of a consumable with a user device. In one embodiment, a consumable item is stored in a cartridge and when the cartridge is coupled to a user device, operation of the user device with cartridge is verified with the assistance of an external system for managing registration information. If verified, operation of the user device and cartridge is enabled and the item within the cartridge is available to be consumed by the system formed by the user device and cartridge.

### CROSS-REFERENCE

This application claims priority to, and the benefit of, under 35 U.S.C. § 119(e) the Nov. 1, 2018 filing date of the U.S. Patent Provisional Application No. 62/781,357 entitled “SYSTEMS AND DEVICES FOR CONTROLLING USE OF REGULATED CONSUMABLES WITH USER DEVICES, AND RELATED SYSTEMS, METHODS, AND DEVICES,” the entire contents and disclosure of which is hereby incorporated herein by this reference.

### TECHNICAL FIELD

Disclosed embodiments relate, generally, to systems and devices for controlling use of an item with certain user device.

### BACKGROUND

Certain items such as regulated consumables, such as alcoholic beverages, medicament, cigarettes, and e-cigarettes, are legally limited to certain age-verified consumers. A typical strategy for combating illicit acquisition and misuse of regulated consumables is age verification (e.g., checking a trusted type of identification to determine if someone meets age requirements to purchase and/or use a product). Another strategy is to use gate keepers that can authorize and monitor use of products, such as using doctors and pharmacists to authorize and monitor prescription drugs. Yet another typical strategy is to use physical means for restricting physical access to the products once they are purchased, such as lock boxes which, in theory, only allow a person with a key or combination to access products stored therein.

However, minors (i.e., a person younger than a legal age limit to acquire and use a regulated consumable) can and do still acquire and use these products. For example, a minor may use fraudulent identification (e.g., a fake driver's license), use an intermediary adult (i.e., a person older than a legal age limit to acquire and use a regulated consumable), or steal from an adult.

Widespread use of fraudulent identification, intermediaries that can acquire age restricted products on behalf of minors, and a black market, limit the effectiveness of these strategies for restricting access/use. Moreover, there is evidence that strategies to control access are not as effective as needed for some regulated consumables.

Since the 1990's, rates of binge drinking of alcohol among United States high school students have declined, until 2017, when the prevalence of binge drinking increased from 2016 along with other measures of alcohol use. Rates of opioid abuse, while decreasing after years of increasing, still are reported at around 4%.

Electronic-cigarettes (E-cigarettes) pose a particular problem because minors often do not appreciate that the liquid vaporized in the e-cigarettes (e-liquid)—which can contain nicotine, propylene glycol, glycerin, and flavorings—is addictive and may be carcinogenic or otherwise present health hazards. Moreover, the vapor that users' inhale, which is an aerosolized version of an e-liquid, may have an enjoyable flavor instead of a tobacco and ash taste commonly associated with cigarettes. A 2017/2018 survey of tobacco use by minors conducted by the United States Food and Drug Administration found such astonishing statistics as: 20.8% of US high school students used an e-cigarette in 2018 (a 78% increase from 2017) and 4.9% of middle school students used an e-cigarette in 2018 (a 48% increase from 2017). Moreover, when asked why they used e-cigarettes, 31% of respondents said it was due to the flavors, and 17% said they believe e-cigarettes are less harmful than forms of tobacco. Overall, in 2018, 3.6 million high school students reported using e-cigarettes. The United States Secretary for Health and Human Services commented about the survey results, stating “these new data show that America faces an epidemic of youth e-cigarette use, which threatens to engulf a new generation in nicotine addiction.”

The inventors of this disclosure appreciate that at least part of the problem of underage use of age restricted products like alcoholic beverages, cigarettes, and e-cigarettes is at least due to poor physical restrictions and tracking. The inventors of this disclosure also appreciate that at least part of the problem of any misuse of regulated products like prescription drugs is also due to poor physical restrictions and tracking.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 shows a simplified block diagram of an example system for controlling use of an item with a user device, in accordance with disclosed embodiments.

FIG. 2A shows a flow chart for a remotely managed process for verifying operation of a cartridge with a battery unit, in accordance with disclosed embodiments.

FIG. 2B shows a flow chart for a process for updating a list of identifiers for cartridges linked to a battery unit, in accordance with disclosed embodiments.

FIG. 2C shows a flow chart for a process for locally managed verification that operation of a battery unit with a cartridge is permitted.

FIG. 3 shows a simplified block diagram of a system for controlling use of an item with a user device, in accordance with disclosed embodiments.

FIG. 4A shows a flow chart for a process for verifying operation of battery unit with a cartridge, in accordance with disclosed embodiments.

FIG. 4B shows a flow chart for a process for managing a locally stored registration information for battery unit using intermediary device, in accordance with disclosed embodiments.

FIG. 5 shows a simplified block diagram of a system for controlling use of an e-liquid where an adapter is configured to verify operation of a battery unit with cartridge is permitted, in accordance with disclosed embodiments.

FIG. 6 shows a circuit diagram for an e-cigarette system, in accordance with disclosed embodiments.

FIG. 7 shows a simplified block diagram of a system for collecting purchaser information and/or device information, in accordance with disclosed embodiments.

FIG. 8 shows a flow chart of a process for collecting device and purchaser information, in accordance with disclosed embodiments.

FIG. 9 shows a flow chart of a process for collecting battery unit information and purchaser information, in accordance with disclosed embodiments.

FIG. 10 shows a flow chart of a process for tagging a cartridge, battery unit, and/or battery adapter with information usable for disclosed embodiments.

FIG. 11 shows a system that includes a microcontroller configured to control use of an item with a user device, in accordance with disclosed embodiments.

FIG. 12 shows a system for controlling operation of an ammunition magazine with a firearm, in accordance with disclosed embodiments.

FIG. 13 shows a system for controlling operation of a magazine with ammunition, in accordance with disclosed embodiments.

FIGS. 14A and 14B show a system for controlling operation of an alcoholic beverage container with an adapter for accessing the container.

FIG. 15 shows a system for controlling delivery of medication by a medication delivery device.

FIG. 16 shows a system for controlling operation of a power tool with a removable power unit, in accordance with disclosed embodiments.

### DETAILED DESCRIPTION

In the following detailed description, reference is made to the accompanying drawings, which form a part hereof, and in which are shown, by way of illustration, specific example embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

It will be readily understood that the components of the embodiments as generally described herein and illustrated in the drawings may be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

The following description may include examples to help enable one of ordinary skill in the art to practice the disclosed embodiments. The use of the terms “exemplary,” “by example,” “for example,” “such as,” and “e.g.,” means that the related description is explanatory, and though the scope of the disclosure is intended to encompass the examples and legal equivalents, the use of such terms is not intended to limit the scope of an embodiment or this disclosure to the specified components, steps, features, functions, or the like.

Thus, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Information and signals described herein may be represented using any of a variety of different technologies and techniques. For example, data, instructions, commands, information, signals, bits, and symbols that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the disclosure may be implemented on any number of data signals including a single data signal.

It should be understood that any reference to an element herein using a designation such as “first,” “second,” and so forth does not limit the quantity or order of those elements, unless such limitation is explicitly stated. Rather, these designations are used herein as a convenient method of distinguishing between two or more elements or instances of an element. Thus, a reference to first and second elements does not mean that only two elements can be employed or that the first element must precede the second element in some manner. Also, unless stated otherwise a set of elements may comprise one or more elements Likewise, sometimes elements referred to in the singular form may also include one or more instances of the element.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field-Programmable Gate Array (FPGA) or other programmable logic device, discrete gate or transistor logic, discrete hardware components, or any combination thereof designed to perform the functions described herein.

A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Also, it is noted that the embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

By way of further example, computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media. Computer-executable instructions may include, for example, instructions and data configured to cause a processor to perform operations associated with disclosed embodiments.

Disclosed embodiments relate, generally, to systems, methods, and devices for controlling use of an item with a user device. An item may be a consumable item, in other words, an item that, during one or more processes involving the user device, would be depleted (i.e., substantially used up) over time. Non-limiting examples of an item may include e-liquid, alcohol, ammunition, ammunition magazines, medicament, chemicals, and power, without limitation. Some items may be regulated, such e-liquid, alcohol, ammunition, and medicament, without limitation. An item may also be an item for which an original equipment manufacturer of a product that incorporates the item desires to prohibit use of the product with certain user devices or promote use of the item with certain user devices. Non-limiting examples of a user device may include a battery unit for an e-cigarette, a medication delivery system, a firearm, an ammunition magazine, a beverage tap system for dispensing alcoholic beverages, and a power tool, without limitation. An item may be held in a cartridge. As non-limiting examples, holding an item may include storing, containing, being charged, being primed, being wound, and being loaded, with limitation.

Some disclosed embodiments relate, generally, to a user device that may be operably coupled to a cartridge with a consumable item held therein. The user device may include a registration module and a communication module, and prior to operable coupling of the user device with the cartridge, the registration module verifies that the user device was linked to the cartridge by a linking system. The registration module may verify the user device was linked to the cartridge by the linking system based, at least in part, on registration information received from an external device (e.g., a server of the linking system, an intermediate device such as a mobile phone, without limitation). The registration information may indicate that operation of the user device with a cartridge is permitted (i.e., the cartridge is “registered” or “linked” to the user device). In some embodiments the registration information may be information that the registration module may use to perform a verification process. In other embodiments the registration information may be a verification result sent by the external device that performed a verification process. If operation is permitted, then registration permits operable coupling of the cartridge to the user device.

Some disclosed embodiments relate, generally, to an adapter that may be operatively coupled to a battery unit and/or an e-liquid cartridge of an e-cigarette system. When coupled to the battery unit and/or e-liquid cartridge, the adapter may regulate (i.e., permit or prohibit) operation of the battery unit with the e-liquid cartridge. In one embodiment, the adapter may enable operable coupling of a battery unit with a registered cartridge to form an operational e-cigarette system. In some embodiments, the adapter may store unique identifying information for linked cartridges and enable operation of a cartridge with a battery unit based, at least in part, on such identifying information. In some embodiments, the adapter may request verification of a cartridge from a linking system and enable operation of a cartridge with a battery unit based, at least in part, on a response from the linking system to the verification request.

In some embodiments, a user device or an adapter may be configured to communicate with a linking system and/or an intermediate device that is configured to communicate with a linking system.

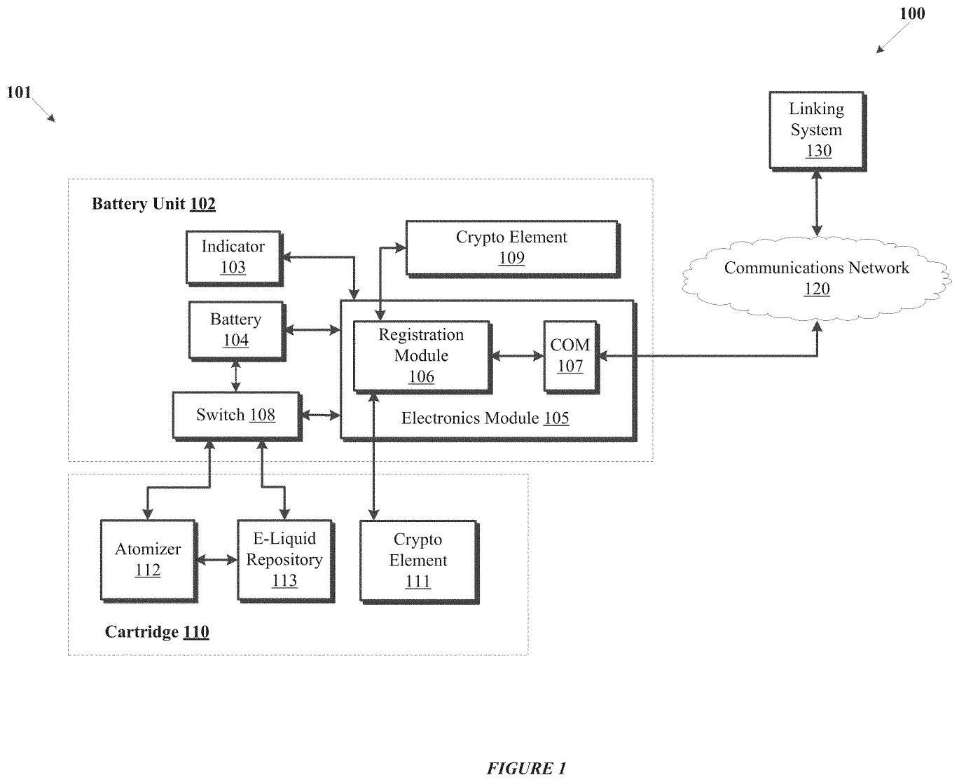

Some embodiments relate to a computer system that is configured to store, update and retrieve registration information (e.g., a linking system such as shown in FIGS. 1, 3, 5 and 7) may be configured to store unique identifying information for the adapter and associate the adapter with battery unit(s) and/or e-liquid cartridge(s). Such association may indicate that operation of a battery unit attached to the adapter with a particular e-liquid cartridge (i.e., a “registered” or “linked” cartridge) is permitted. A communications module may be configured to form a communications link with a remote server or intermediate device (e.g., a mobile phone, personal computer, wearable device, etc.) and thereby enable a registration module to interface with the computer system.

It will be appreciated by one having ordinary skill in that art that disclosed embodiments have many applications. For example, to control use of ammunition and/or magazines with specific firearms, to control use of alcoholic beverages with specific adapters, to control use of medication with specific delivery systems, to control use of batteries with power tools, without limitation.

FIG. 1 shows a simplified block diagram of a system 100 for controlling use of a regulated consumable, in accordance with disclosed embodiments. More specifically, in the embodiment shown in FIG. 1, system 100 is for controlling use of cartridge 110 containing e-liquid in e-liquid repository 113 with a battery unit 102 (e.g., a user device). System 100 may include e-cigarette system 101, communication network 120, and linking system 130. E-cigarette system 101 may include battery unit 102 and cartridge 110. E-cigarette system 101 and linking system 130 may be operatively coupled to communication network 120 by wired and/or unwired communication paths that, together with communication network 120, are configured to facilitate communication between e-cigarette system 101 and linking system 130.

By way of example, communication network 120 may be one or more wired and/or wireless communication networks such as the Internet, local area networks (LAN), wide area networks (WAN), personal area networks (PAN), virtual private networks (VPN), mobile data networks, public switched telephone networks (“PSTN”), and/or cellular networks.

Battery unit 102 is configured, generally, to provide power to cartridge 110, and more specifically, provide power to atomizer 112 which, when powered, draws e-liquid stored in e-liquid repository 113 and vaporizes the e-liquid for inhalation by a user. The timing and amount of power delivered from battery 104 may be, at least in part, controlled by electronics module 105. In various embodiment, electronics module 105 may be configured to provide power to cartridge 110 responsive, for example, to a user pressing a button or responsive to a user trying to inhale vapor using a mouthpiece. Electronics module 105 may be configured to provide visual and/or audible indicators 103 related to an operation or a state of battery unit 102, cartridge 110, and/or e-cigarette system 101.

Battery unit 102 is configured, generally, to verify that operation of battery unit 102 with cartridge 110 is permitted. In the example shown in FIG. 1, electronics module 105 includes registration module 106 and COM 107, which are part of electronics module 105. Registration module 106 is configured to read cartridge information from crypto element 111 of cartridge 110, verify that operation of cartridge 110 with battery unit 102 is permitted (as disclosed herein), and permit operable coupling of cartridge 110 with battery unit 102 if verification is successful.

As used herein “operable coupling” of a first and a second element means that the first and second element are physically and electrically coupled such that they can operate as a system.

Battery unit 102, and cartridge 110 may include one or more circuits and communication interfaces and system busses for transferring information and communicating messages related to performing operations of embodiments described herein. Communication interfaces and system busses may be for any combination of serial and parallel buses, for example, inter-integrated circuit (I²C), one wire interface, universal serial bus (USB), serial peripheral interface (SPI), controller area network (CAN), IEEE 1394, peripheral component interconnect (PCI), PCI express, and/or external bus interface (EBI). Wireless techniques such as a Bluetooth Low Energy (BLE) or Near Field Communication may also be used to transfer information and communicate messages between battery unit 102, and external devices through COM 107.

Battery unit 102 and cartridge 110 are configured to be releasably coupled to each other. In one embodiment, battery unit 102, and cartridge 110 may include physical features (not shown) for interference coupling of the devices. Physical features for interference coupling may include, for example, threaded recesses and complimentary threaded recesses, features for snap-together coupling, and/or frictional features.

In one embodiment, battery unit 102 is intended to be reusable and cartridge 110 is intended to be disposable, and in another embodiment both battery unit 102 and cartridge 110 are intended to be reusable.

In the embodiment shown in FIG. 1, electronics module 105 is an embedded system (i.e., for operating an e-cigarette system) that includes registration module 106 and COM 107. In another embodiment, registration module 106 and COM 107 may be embedded systems. Embedded systems according to disclosed embodiments may be, for example, microcontroller type embedded systems.

COM 107 is a communication interface configured for establishing communications links over one or more wired and/or wireless paths. In some embodiments, COM 107 is configured to establish communication links with linking system 130 over communication network 120. In other embodiments, COM 107 may be configured for establishing a communications link with an external device in close proximity to COM 107 for example, using Bluetooth Low Energy, Near Field Communication, or a data cable. As non-limiting examples, COM 107 may be a radio configured for wireless communication or a port configured for serial and/or parallel communication with a computing device or network communication equipment. A radio may be configured for wireless communication according to one or more commercially available standards, for example, BLUETOOTH®, WiFi, ZIGBEE®, or a cellular communication.

Switch 108 may be configured to enable and disable electrical connectivity between battery unit 102 and cartridge 110, and components thereof. In the embodiment shown in FIG. 1, switch 108 is configured to inhibit or facilitate transfer of power from battery 104 to atomizer 112 and/or e-liquid repository 113. Switch 108 may be, for example, a Field Effect Transistor (FET).

Registration module 106 may be configured to use authentication information about battery unit 102 received from crypto element 109 of battery unit 102 to authenticate battery unit 102 to remote networks and systems such as Linking System 130.

In some embodiments, crypto element 109 may only include (e.g., store or be able to reconstruct or recover) authentication information. In one embodiment, crypto element 109 may be configured to store battery unit information in addition to authentication information. As a non-limiting example, battery unit information may include, a unique identifier (i.e., a battery unit identifier) for battery unit 102 that is written to crypto element 109 at a manufacturing site.

Crypto element 111 of cartridge 110 may be configured to store authentication and cartridge information such as a cartridge identifier. In one embodiment, the cartridge identifier may be written to crypto element 111 at a manufacturing site. In one embodiment, registration module 106 is configured to retrieve serial numbers from linking system 130 while battery unit 102 is connected to linking system 130 via COM 107 and Communication Network 120, and optionally store the retrieved serial numbers in crypto element 109.

Registration module 106 may be configured to retrieve authentication information and/or cartridge information (e.g., a manufacturer's serial number or a government issued serial number, without limitation) from crypto element 111 of cartridge 110. Registration module 106 may be configured to use retrieved cartridge information to verify that operation of cartridge 110 with battery unit 102 is permitted, as more fully described herein. In one embodiment, registration module 106 may be configured to use authentication information of the cartridge to authenticate that cartridge 110 is an OEM cartridge.

Crypto element 109 and crypto element 111 may be, for example, a security chip or integrated circuit (IC) that is configured to store authentication information and/or secret information (e.g., store certificates, digest, keys, passwords, read-only data, and/or secrete data on computer readable storage media), perform cryptographic techniques (e.g., perform secure hash algorithms), and provide information to other devices as requested. In one embodiment, crypto elements 109 and 111 may have a limited interface (e.g., a single input/output pin) and full metal shields over all of the internal circuitry, so if an attacker cuts or short circuits any trace in the shield, the crypto elements 109 and 111 stop functioning. In one embodiment, crypto elements 109 and 111 may include one or more of an internal clock, voltage generation, encrypted memory, and tamper detection capability.

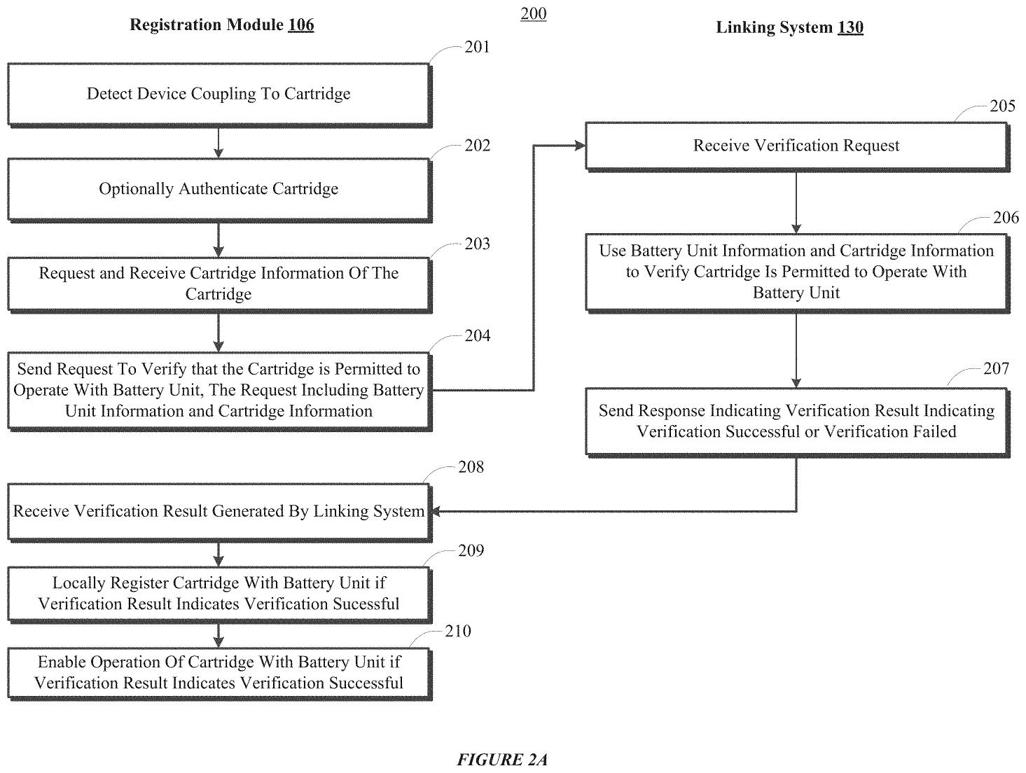

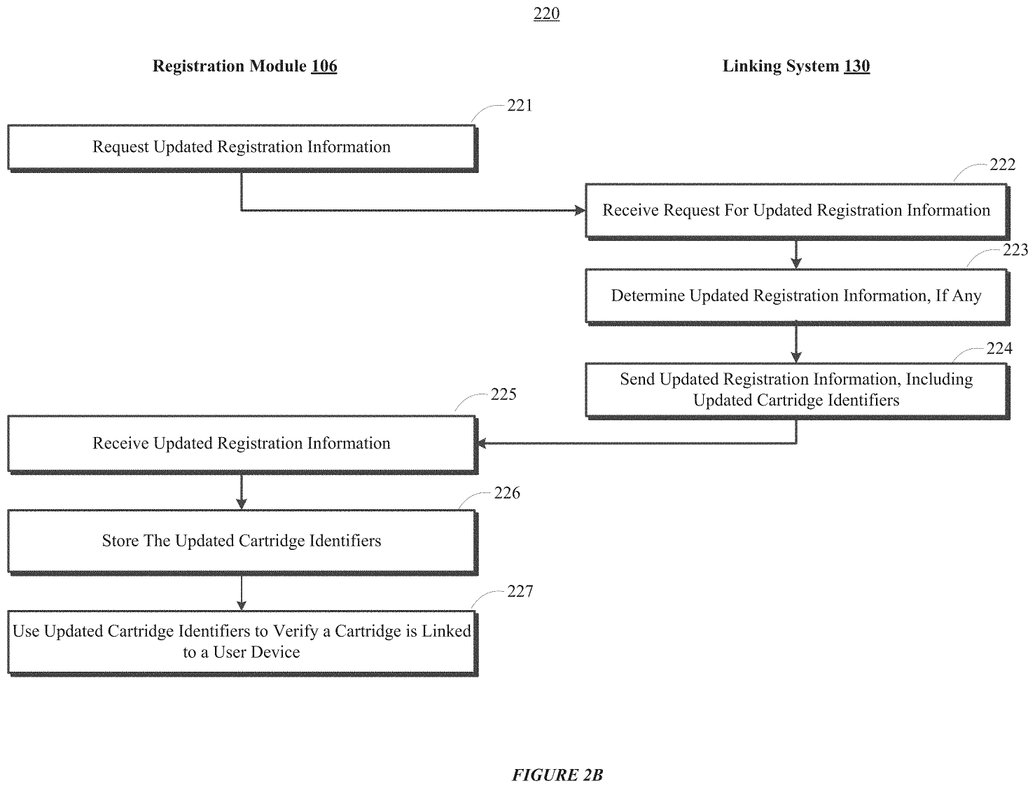

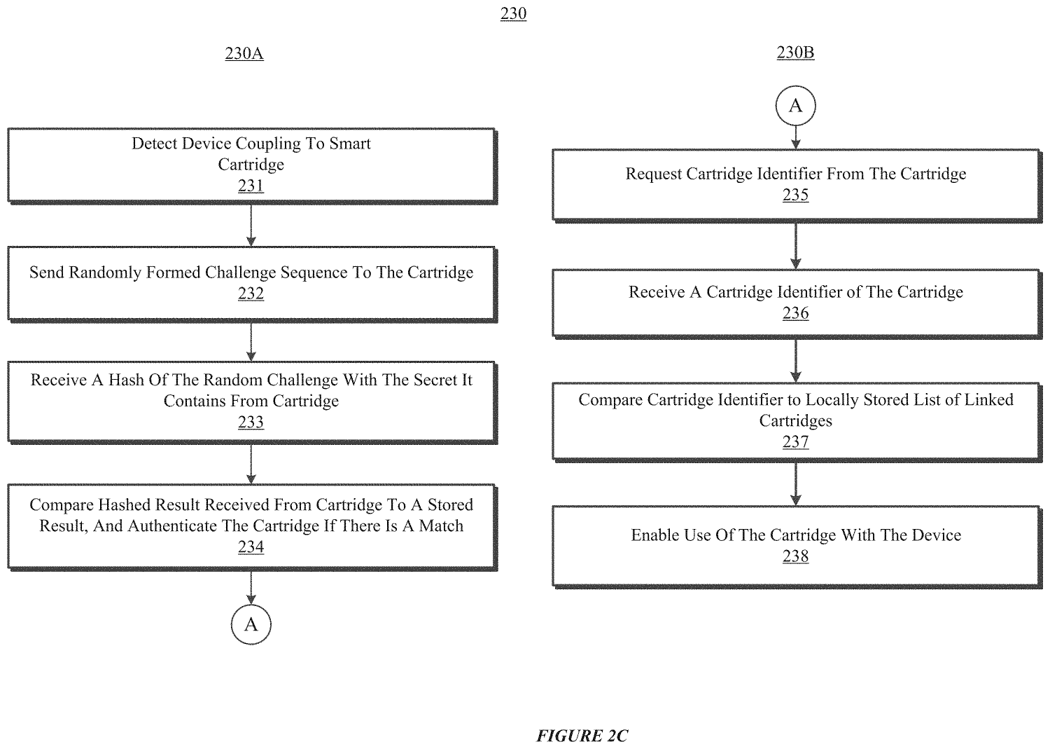

In disclosed embodiments, registration module 106 may be configured for a locally managed mode of operation, a remotely managed mode of operation, or both. While operating in a contemplated locally managed mode of operation, registration module 106 may be configured to use a locally stored (i.e., stored at battery unit 102) list of identifiers for cartridges linked to battery unit 102 to verify cartridge 110. For example, a list of identifiers may be stored at crypto element 109. Registration module 106 enables operation of cartridge 110 with battery unit 102 if the identifier for cartridge 110 matches one of the stored identifiers for cartridges linked to battery unit 102. An example verification process of a locally managed mode of operation is described with reference to FIG. 2C.

While operating in a contemplated remotely managed mode of operation, registration module 106 may be configured to send a request including a cartridge identifier for cartridge 110 to linking system 130, which manages a list of identifiers for cartridges linked to battery unit 102 (i.e., a list of registered cartridges). Registration module 106 then enables operation of cartridge 110 with battery unit 102 in response to the linking system 130 approving the request. An example verification process of a remotely managed mode of operation is described with reference to FIGS. 2A and 2B.

In one embodiment, to enable operation of cartridge 110 with battery unit 102, registration module 106 may be configured to control switch 108 to enable power transfer from battery unit 102 to cartridge 110 only after a successful verification.

FIG. 2A shows a flow chart of an example process 200 for a remotely managed process for verifying operation of a cartridge 110 with a battery unit 102, in accordance with disclosed embodiments. In operation 201, registration module 106 detects that cartridge 110 has been coupled to battery unit 102. Any suitable technique may be used to detect cartridge 110 is coupled to e-cigarette system 101, for example, detecting an additional load at switch 108 or at registration module 106. In operation 202, registration module 106 optionally authenticates cartridge 110 using a challenge sequence. In operation 203, cartridge 110, registration module 106 queries cartridge 110 for cartridge information and cartridge information is received from cartridge 110. In operation 204, a request is sent to linking system 130 to verify that cartridge 110 is permitted to operate with battery unit 102. The request may be transmitted via COM 107. The request may include battery unit information and cartridge information, for example, the retrieved cartridge identifier (i.e., a unique identifier for cartridge 110 received in operation 203) and a battery unit identifier (i.e., a unique identifier for battery unit 102 or battery adapter 107).

In operation 205, linking system 130 receives the verification request from registration module 106. In operation 206, linking system 130 uses the optional battery unit information and cartridge information to verify that cartridge 110 is permitted to operate with battery unit 102. In one embodiment, linking system 130 uses the battery unit identifier to look-up a record associated with the battery unit identifier and searches the record to determine if the cartridge identifier is on a list of identifiers for cartridges linked to battery unit 102. In operation 207, linking system 130 may be configured to send a response to registration module 106 that indicates whether verification was successful or failed. In operation 208, registration module 106 receives the response, which in this example indicates that verification was successful. In operation 209, registration module 106 locally registers cartridge 110 with battery unit 102 by storing the cartridge identifier for cartridge 110 in a locally managed list of identifiers for cartridges that are linked to battery unit 102. In operation 210, registration module 106 enables use of cartridge 110 with battery unit 102, such as by closing switch 108 to provide power to cartridge 111 from batter unit 102. If verification failed, operation of battery unit 102 with cartridge 110 is not enabled.

FIGS. 2B and 2C show aspects of a locally managed process for verifying operation of cartridge 110 with battery unit 102, in accordance with disclosed embodiments. More specifically, FIG. 2B shows a flow chart of a process 220 for updating a list of identifiers for cartridges linked to a battery unit, in accordance with disclosed embodiments; and FIG. 2C shows a flow chart of a process 230 for verifying operation of cartridge 110 with battery unit 102, in accordance with disclosed embodiments.

Turning to process 220 shown in FIG. 2B, in operation 221, registration module 106 sends a request for updated registration information for battery unit 102 to linking system 130 via COM 107 and through communications network 120. Updated registration information may include, for example, identifiers for cartridges linked to battery unit 102. In operation 222, linking system 130 receives the request for updated registration information, and in operation 223 determines updates, if any. In one embodiment, linking system 130 may be configured to determine changes to registration information for battery unit 102 since receiving a previous request for updated registration information from registration module 106, and create updated registration information reflecting those changes. In another embodiment, linking system 130 may be configured to identify the most current registration information for battery unit 102, and create updated registration information based on the most current registration information. In operation 224, linking system 130 sends a response to registration module 106, which response includes updated registration information determined in operation 223. In this example, the updated registration information includes cartridge identifiers for cartridges that linking system 130 has linked to battery unit 102. Additionally or alternatively, registration information may include cartridge identifiers for cartridges that are no longer linked to battery unit 102. In operation 225, registration module 106 receives the updated registration information, and in operation 226, stores the updated cartridge identifiers. Storing updated registration information may include, for example, adding and/or removing cartridge identifiers to a locally stored list of identifiers for cartridges linked to battery unit 102 based, at least in part, on the received updated registration information. Optionally, a locally stored list of identifiers for cartridges linked to battery unit 102 is stored encrypted in crypto element 109.

FIG. 2C shows a flow chart of a process 230 for locally managed verification that operation of a battery unit with a cartridge is permitted performed at e-cigarette system 101 of FIG. 1. The embodiment shown in FIG. 2C includes two sub-processes, sub-process 230A for authenticating a cartridge and 230B for verifying that the cartridge is permitted to operate with a battery unit. In some embodiments, a cartridge authenticated by process 230A may also be deemed verified to operate with a battery unit, and thus sub-process 230B may not be required.

In operation 231, coupling of cartridge 110 to battery unit 102 is detected. In operation 232, a randomly formed challenge sequence is sent to the cartridge 110. In operation 233 cartridge 110, particularly the crypto element 111, computes a hash of the random challenge with the secret it contains and returns the hash to battery unit 102, particularly to registration module 106. In operation 234, the registration module 106 compares the hashed result received from cartridge 110 to a stored result (e.g., stored at crypto element 109), and if it matches the stored result, authenticates this cartridge 110.

In step 235 cartridge 110 is queried for a cartridge identifier. In operation 236, a cartridge identifier is received from cartridge 110. In operation 237, the received cartridge identifier is compared to a locally stored list of identifiers for cartridges linked to battery unit 102. In operation 238, operation of cartridge 110 with battery unit 102 is enabled responsive to verifying that received cartridge identifier matches one of 110 a locally stored list of identifiers for cartridges, such as by closing switch 108 to provide power to cartridge 110 from battery unit 102.

Disclosed embodiments described with reference to FIGS. 1 through 2B show battery unit 102, and more specifically, registration module 106 and COM 107, communicating directly with linking system 130. However, some disclosed embodiments relate, generally, to a battery unit that communicates with a linking system via an intermediary device such as a mobile phone. By way of example, such a battery unit may not have components for internet connectivity or may be configured to use a subset of its communication capability to conserve power. So, in some disclosed embodiments, an intermediary device communicates with a linking system or relays messages from a battery adapter to a linking system.

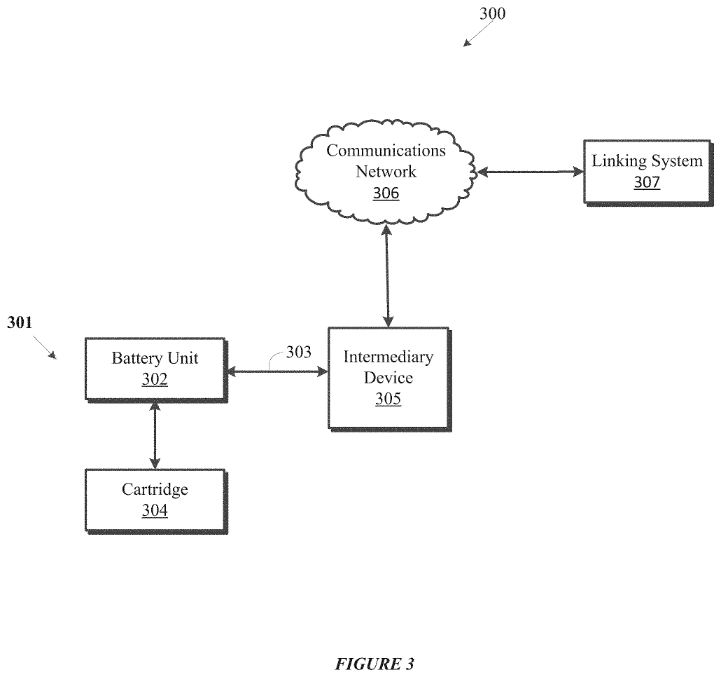

FIG. 3 shows a simplified block diagram of a system 300 for controlling use of a regulated item with a user device, and more specifically in this example, use of a cartridge 304 containing e-liquid with battery unit 302 of an e-cigarette system 301. In the example shown in FIG. 3, e-cigarette system 301 includes battery unit 302 and cartridge 304. Battery unit 302 and cartridge 304 are configured, generally, as described with reference to battery unit 102 and cartridge 110, respectively, with the exception that battery unit 302 is not configured for, or lacks components for, communicating over communication network 306.

Battery unit 302 connected to intermediary device 305 by way of a close proximity communication link 303. Intermediary device 305 sits between e-cigarette system 301 and linking system 307 and handles messaging between linking system 307 and e-cigarette system 301 related to verifying that operation of battery unit 302 with cartridge 304 is permitted. In one embodiment, intermediary device 305 provides Internet connectivity to e-cigarette system 301 and, more specifically, to battery unit 302; and is configured to relay messages between battery unit 302 and linking system 307, through communications network 306, for example, to perform embodiments described with reference to FIGS. 1 through 2B.

In various embodiments, intermediary device 305 may be, for example, a computing device executing an application for performing one or more operations of disclosed embodiments. The computing device may be, for example, a smart phone, a tablet computer, a laptop computer, a desktop computer, a kiosk, a terminal, a smart speaker, smart headphones, a smart watch, an automobile sub-system, or a custom computing device.

In another embodiment, intermediary device 305 is configured to provide services related to a locally managed mode of operation or a remotely managed mode of operation of battery unit 302 similar to what was described with reference to FIGS. 2B and 2C. In such an embodiment, intermediary device 305 is configured to store and manage registration information (e.g., a list of identifiers for cartridges linked to battery unit 302), and to, depending on a mode of operation, periodically provide updated registration information to battery adapter 303 or verify operation of battery adapter 303 with a cartridge such as cartridge 304.

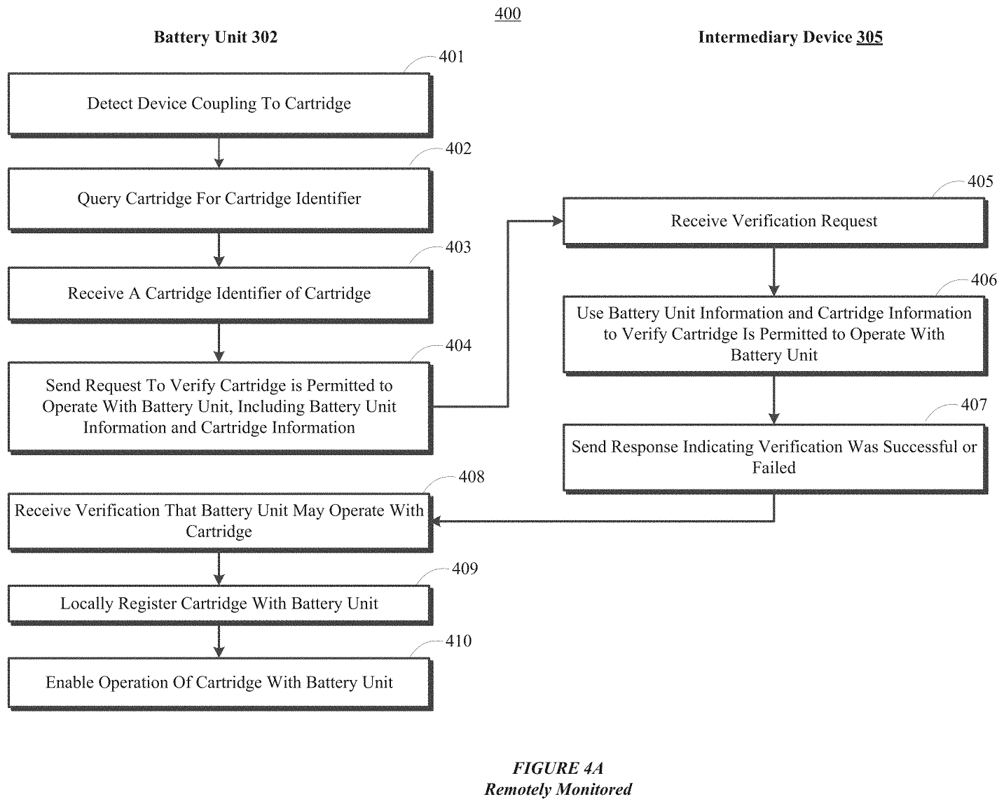

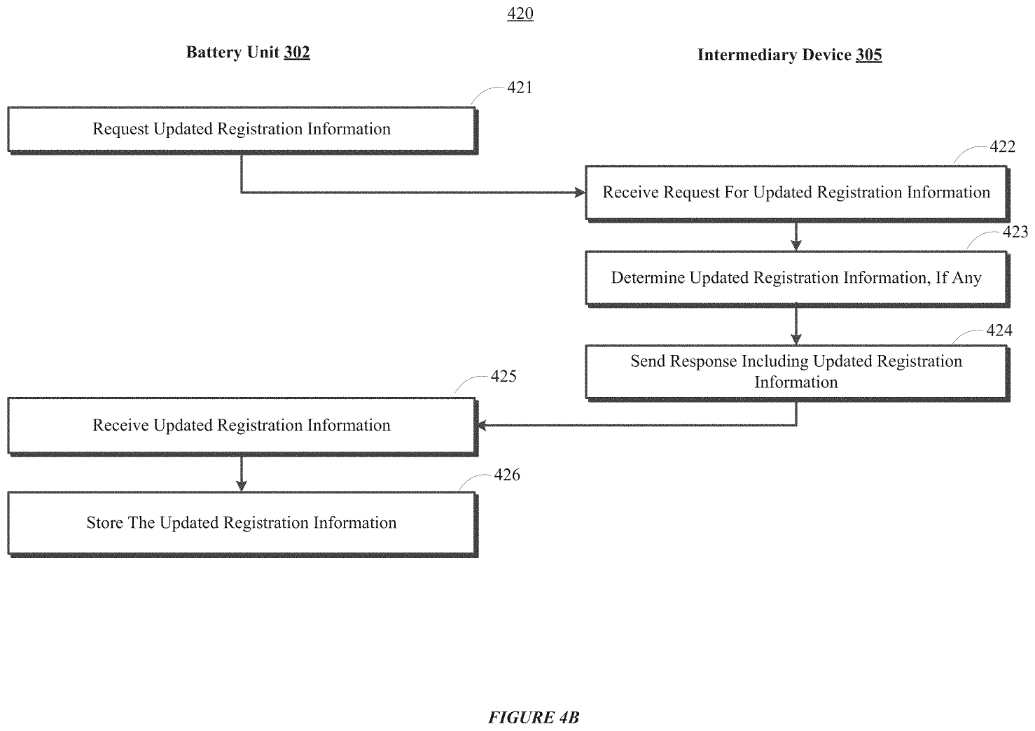

FIG. 4A shows a flow chart of a process 400 for verifying operation of battery unit 302 with cartridge 304, in accordance with disclosed embodiments. In operation 401, coupling of cartridge 304 is detected. In operation 402, cartridge 304 is queried for its cartridge identifier, and in operation 403 the cartridge identifier for cartridge 304 is received. In operation 404, a request is sent to intermediary device 305 to verify cartridge 304 is permitted to operate with battery unit 302. In one embodiment, the request includes cartridge information and optionally battery unit information, which may include a battery unit identifier for battery unit 302 and a cartridge identifier for cartridge 304. In operation 406, intermediary device 305 receives the verification request including the cartridge information and the optional battery unit information. In operation 306, intermediary device 305 uses the cartridge information and optional battery unit information to verify if cartridge 304 is permitted to operate with battery unit 302. In one embodiment, intermediary device 305 compares locally stored registration information for the battery unit 302 to the cartridge information, for example, comparing a cartridge identifier for cartridge 304 with a list of identifiers for cartridges linked to battery unit 302. In another embodiment, intermediary device 305 relays the query to linking system 307 and receives its response. In operation 407, intermediary device 305 sends a response indicating that the verification was successful or a failure to battery unit 302.

In operation 408, battery unit 302 receives verification that battery unit 302 may operate with cartridge 304, and in operation 409 locally registers cartridge 304 with battery unit 302 (e.g., updates locally stored registration information for battery unit 302). In operation 410, battery unit 302 enables operation of cartridge 304 with battery unit 302, such as by closing switch 108 to provide power to cartridge 111 from battery unit 102.

A flow chart for an example process 420 for managing a locally stored registration information for battery unit 302 using intermediary device 305 is shown in FIG. 4B. In operation 421, battery unit 302 requests updated registration information from intermediary device 305. In operation 422, intermediary device 305 receives the request for updated registration information. In operation 423, intermediary device 305 determines that there is updated registration information, and, in operation 424, sends a response to battery unit 302 that includes the updated registration information determined in operation 423. In operation 425, battery unit 302 receives the updated registration information, and, in operation 426, stores the updated registration information. The updated registration information may be used in the manner described with reference to FIG. 2C to verify operation of cartridge 304 with battery unit 302 is permitted.

One of ordinary skill in the art will appreciate that other architectures then those described herein may be implemented consistent with disclosed embodiments.

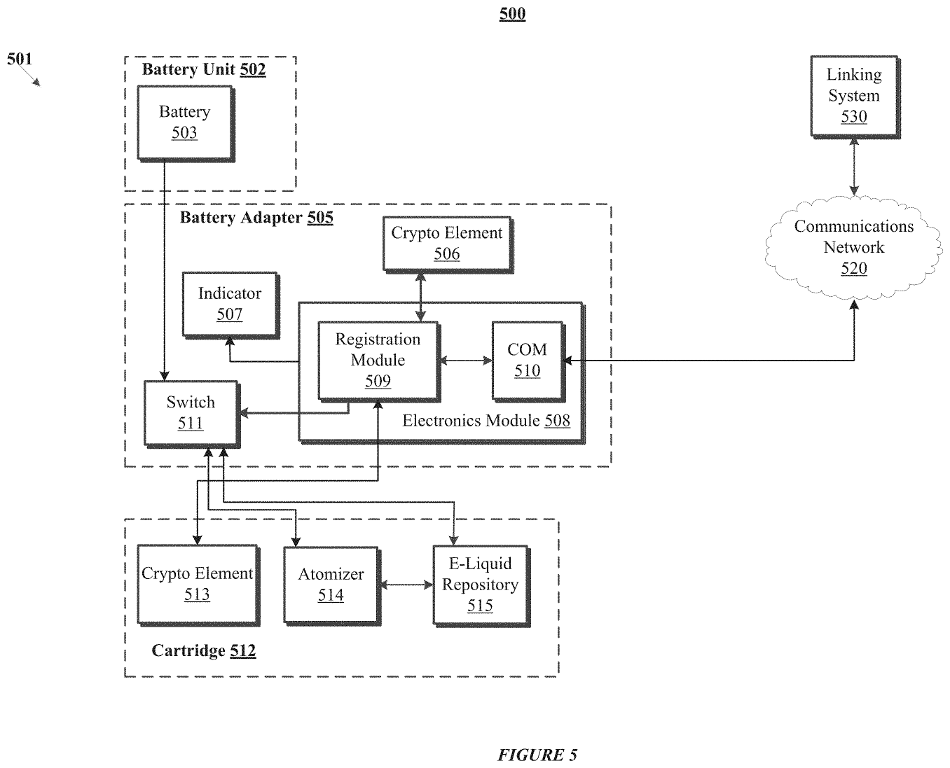

FIG. 5 shows a simplified block diagram of a system 500 configured, generally, for controlling use of an item with a user device, in accordance with disclosed embodiments. Unlike system 100, where switch 108, registration module 106 and COM 107 are part of battery unit 102, in system 500, indicator 507, switch 511, electronics module 508, registration module 509, and COM 510 are part of a battery adapter 505.

It is specifically contemplated that in some cases battery units, such as battery unit 502, will not include communication equipment or interfaces for connecting to communication equipment. Battery adapter 505 provides the communication functionality as well as functionality for verifying that cartridge 512 is permitted to operate with battery unit 502. Battery adapter 505 also includes crypto element 506 which may be used, as a non-limiting example, for secure, encrypted, storage of registration information.

Battery unit 502 and cartridge 512 are configured to each be releasably coupled to battery adapter 505. In operation, once battery unit 502 and cartridge 512 are operably coupled to battery adapter 505, elements operate as like-named elements in FIG. 1, and may perform the operations of embodiments described with reference to FIGS. 2A, 2B, 2C and 3, 4A and 4B.

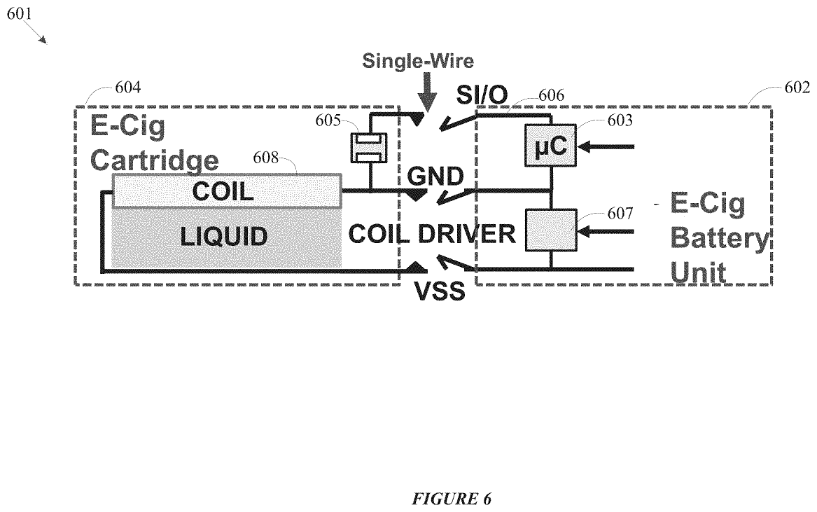

FIG. 6 shows a circuit diagram for an e-cigarette system 601 that is an embodiment of e-cigarette system 100 of FIG. 1. In the embodiment shown in FIG. 6, battery unit 602 of e-cigarette system 601 includes a microcontroller 603 and cartridge 604 includes a security chip 605. When battery unit 602 and cartridge 604 are connected, microcontroller 603 and security chip 605 may communicate across input/output (I/O) wire 606. For example, microcontroller 603 may request a cartridge identifier stored at security chip 605, including using challenge/response techniques to authenticate cartridge 604. If cartridge 604 is verified, microcontroller 603 may be configured to enable coil driver 607 of battery unit 602 to drive coil 608 of cartridge 604. In one embodiment the SI/O and VSS signals may be carried over the same physical wire such that there are only two wires connecting the cartridge and the battery unit.

Some disclosed embodiments relate to collecting purchaser information and/or device information (e.g., information about a cartridge or about a battery unit) during or in conjunction with one or more sale transactions. Such collected information may be sent to a linking system to be used to control operation of the devices. One or more processing apparatuses associated with a point-of-sale may be configured to collect purchaser information and device information. A point-of-sale may be, for example, a point-of-sale, a point of purchase, or a point-of-service at a retail location; or a point-in-time that an online sale transaction is complete. A processing apparatus may be, for example, an electronic device located at a point-of-sale, a point-of-sale device, or an electronic device operatively coupled (e.g., by a direct data connection, over a local or wide area network, over the Internet, or combinations thereof) to a point-of-sale device; or one or more devices and/or computers (e.g., servers or virtual machines) that are part of an e-commerce system and/or an inventory management system.

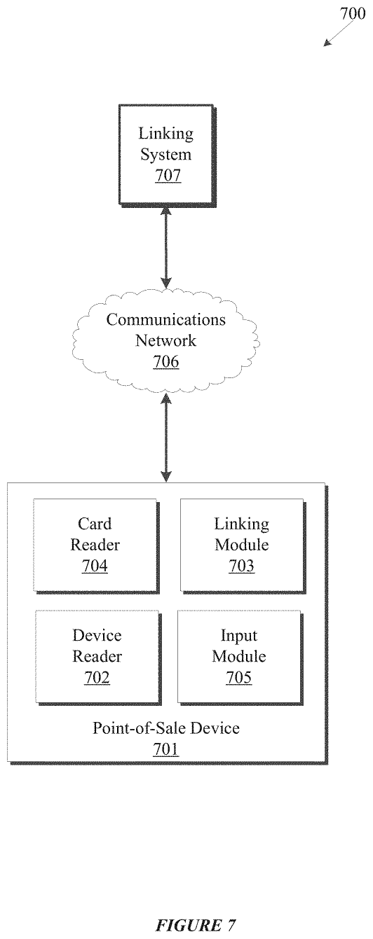

FIG. 7 shows a simplified block diagram of a system 700 for collecting purchaser information and/or device information, in accordance with disclosed embodiments. System 700 may include a point-of-sale device 701 configured to collect purchaser information, battery unit information, and cartridge information at a point-of-sale during or in conjunction with a sale of a battery unit or a cartridge. Point-of-sale device 701 may include device reader 702, linking module 703, card reader 704, and input module 705. Device reader 702 is configured, generally, to read battery unit information and/or cartridge information stored on an element affixed to a battery unit or cartridge. An element may be, for example, a barcode, RFID tag, or a chip.

Card reader 704 is configured, generally, to gather identifying information about a purchaser (i.e., purchaser information) during a transaction involving a battery unit or a cartridge. In particular, card reader 704 may be configured to read purchaser information from a crypto element of an identification (ID) card. A crypto element of an ID card may be, for example, a magnetic stripe, an embedded chip, or a barcode. An ID card may be, for example, a credit card, a debit card, a store-value card, a business loyalty card, a government issued ID (e.g., a driver's license or a passport), or other form of trustworthy ID.

It is not required that an ID card actually be present at a point-of-sale. For example, purchaser information associated with an ID card may be stored on a smart device (e.g., a smart phone) and be readable from a standard interface for a smart device (e.g., a display), an embedded chip on a smart device, a reprogrammable magnetic stripe, or the like. For example, card reader 704 may be configured to read purchaser information from a barcode generated on a display of a smart device or from a chip using NFC.

Purchaser information may also be entered manually at point-of-sale device 701 using input module 705. For example, a cashier, customer service representative, or even a customer may enter information about a purchaser from an ID card using input module 705.

In some embodiments, point-of-sale device 701 may prompt a purchaser to confirm purchaser information collected by card reader 704 and/or entered manually using input module 705. For example, point-of-sale device 701 may display some, or all, of the collected purchaser information and provide a prompt to a user to confirm the displayed purchaser information is correct using a confirmation feature. A confirmation feature may be, for example, a button or an electronic signature. In some embodiments, a record of a purchaser's confirmation may be added to purchaser information sent to linking system 707.

Linking module 703 is configured, generally, to provide device information and purchaser information to linking system 707 through communications network 706. In particular, linking module 703 may be configured to send purchaser and device information to linking system 707 collected during, or in conjunction with, a sale transaction. Purchaser information may include, for example, a purchaser's name, age, gender, address, driver's license number, social security number, and/or other identifying information.

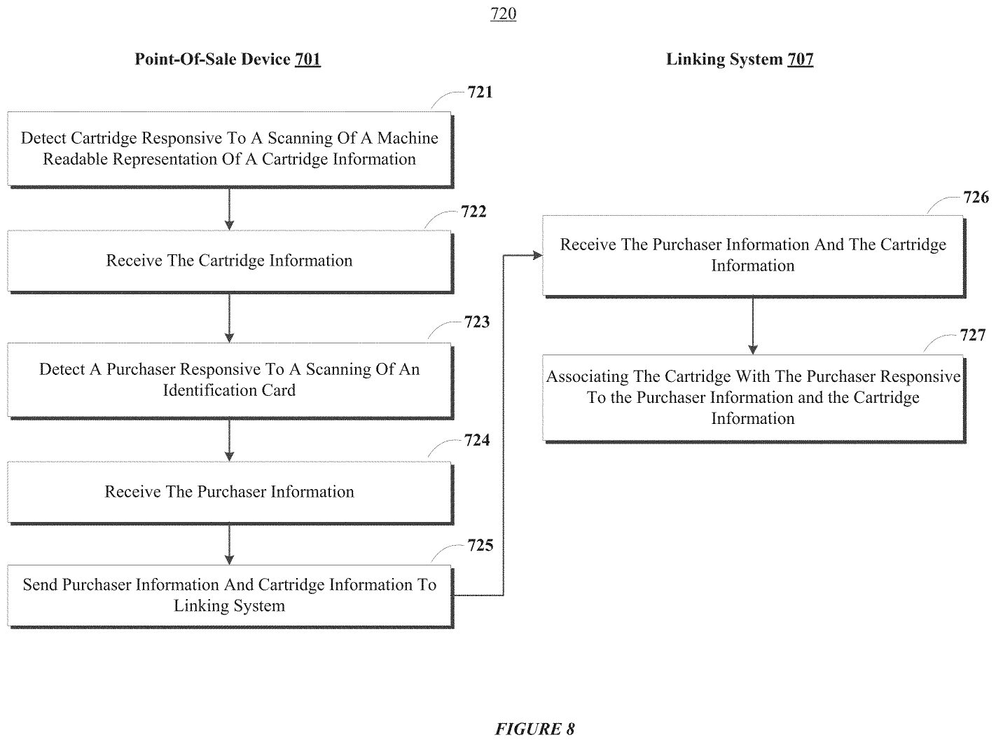

FIG. 8 shows a flow chart of a process 720 for collecting device and purchaser information in accordance with disclosed embodiments. In operation 721, a cartridge is detected responsive to a scanning of a machine readable representation of a cartridge information. In operation 722, the cartridge information is received (i.e., cartridge information is obtained responsive to scanning the machine readable representation of the cartridge information). In operation 723, a purchaser is detected responsive to a scanning of an ID card. In operation 724, a purchaser information is received (i.e., purchaser information is obtained in response to scanning the identification card). In operation 725, the purchaser information and cartridge information are sent to linking system 707 (e.g., using communication network 706).

In operation 726, linking system 707 receives the purchaser information and cartridge information. In operation 727, the cartridge is associated with the purchaser responsive to the purchaser information and cartridge information. In one embodiment, a received cartridge serial number is added to a record of cartridge serial numbers permitted to operate with one or more battery units associated with purchase information, as will be described below in relation to process 740. These records may be retrieved, for example, using the purchaser information.

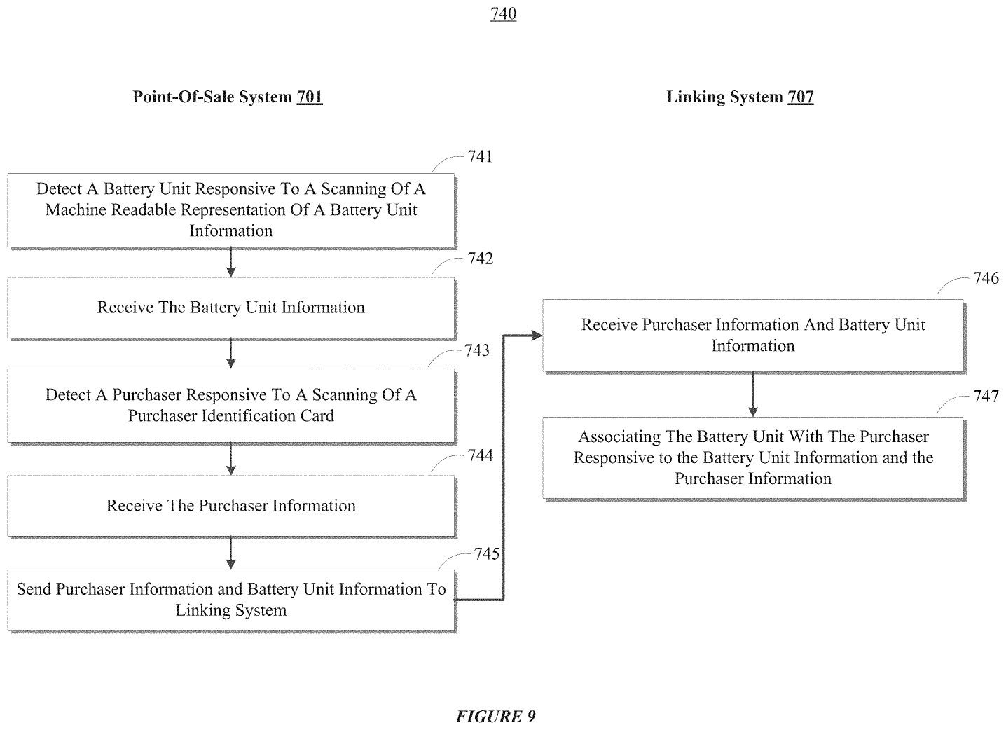

FIG. 9 shows a flow chart of a process 740 for collecting battery unit information and purchaser information in accordance with disclosed embodiments. In operation 741, a battery unit is detected at the point-of-sale device responsive to scanning a machine readable representation of battery unit information. In operation 742, battery unit information is received (i.e., battery unit information is obtained responsive to scanning the machine readable representation of the battery unit information). In operation 743, a purchaser is detected responsive to a scanning of an ID card. In operation 744, a purchaser information is received (i.e., purchaser information is obtained responsive to scanning the purchaser's identification card). In operation 745, the purchaser information and battery unit information are sent to linking system 707.

In operation 746, linking system 707 receives the purchaser information and battery unit information. In operation 747, the linking system 707 associates the battery unit with the purchaser in response to the purchaser information and the battery unit information. In one embodiment, a battery unit serial number and purchaser information is added to a record, which may then be retrieved using battery unit serial number and/or purchaser information. In one embodiment, the battery unit information is a serial number or other identifier for a registration module that is incorporated into the battery unit (e.g., registration module 106).

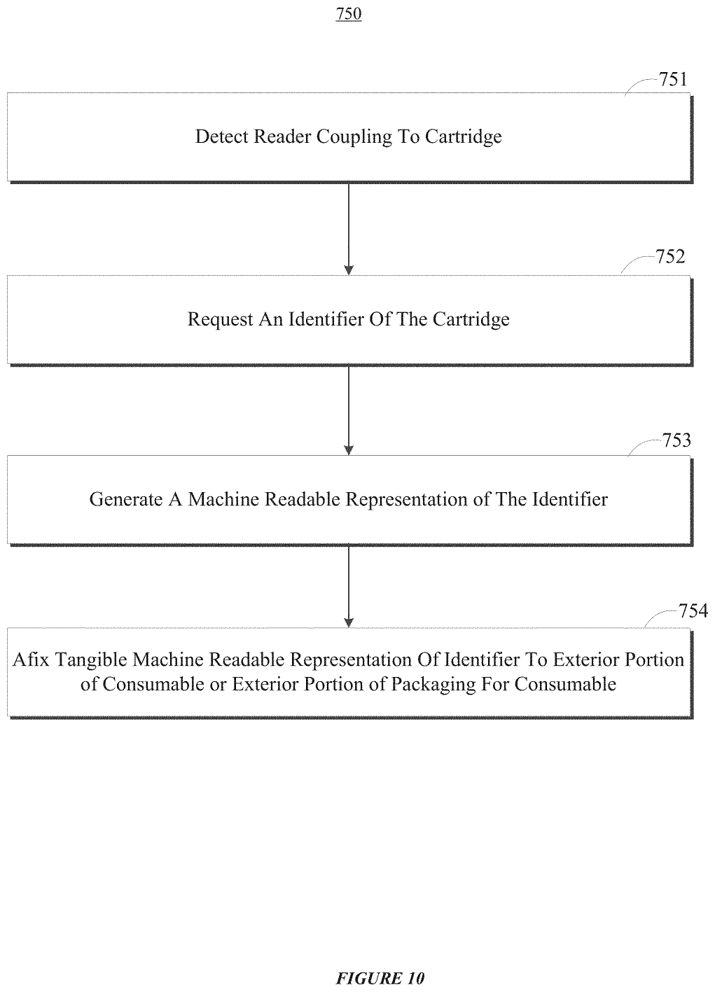

FIG. 10 shows a flow chart of a process 750 for tagging a cartridge, battery unit, and/or battery adapter with information usable for disclosed embodiments. In operation 751, coupling of a cartridge to a reader device is detected. In operation 752, an electronic identifier of the cartridge is requested. The electronic identifier may be stored in a crypto element of the cartridge. In operation 753, a machine readable representation of the identifier is generated, e.g., by the crypto element of the cartridge. In operation 754, a tangible machine readable representation of the cartridge identifier is affixed to an exterior portion of the cartridge or to an exterior portion of packaging for the cartridge. A machine readable representation may be, for example, an alpha-numeric code, and a tangible version of the machine readable representation may be a bar code. Such a bar code may printed on an exterior surface of a cartridge or user device, or onto another medium that is adhered to an exterior surface of the cartridge.

While examples shown in FIGS. 7 through 10 are described in terms of a battery unit and battery unit information (such as embodiments described with reference to FIG. 1), they are applicable to embodiments described with reference to FIG. 5. In other words, a registration module may be configured to collect cartridge information and battery adapter information and send the collected information to a linking system. The linking system may be configured to associate the battery adapter information with the cartridge information.

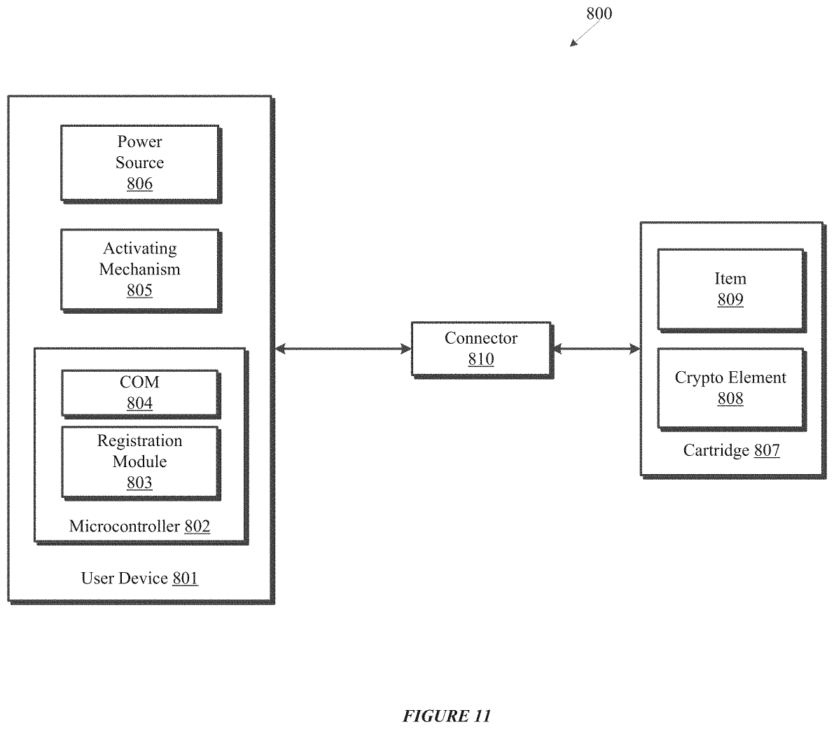

One of ordinary skill in the art will appreciate that disclosed embodiments are applicable to control use of cartridge other than e-liquid cartridges. FIG. 11 shows a system 800 that includes a microcontroller 802 that, in various embodiments, may be part of an embedded system of a user device 801 or its own device affixed to or incorporated into user device 801. While cartridge 807 is operably coupled to user device 801, activating mechanism 805 may, while enabled, cause the overall system 800 to, by various processes, deplete item 809 stored in cartridge 807. The principle of operation of activating mechanism 805 will vary based on application, and may be, for example, an actuator, a pump, a heating element, an aerosolizer, or a chamber for a chemical reaction.

Microcontroller 802 may include a registration module 803 and COM 804 that are configured to verify whether operation of user device 801 with cartridge 807 is permitted in accordance with disclosed embodiments. Crypto element 808 of cartridge 807 may include cartridge information that registration module 803 may read and use to verify operation of cartridge 807 with user device 801 is permitted. If operation is successfully verified, registration module 803 may be configured to enable activating mechanism 805, thus enabling delivery of power from power source 806 to cartridge 807 via connector 810.

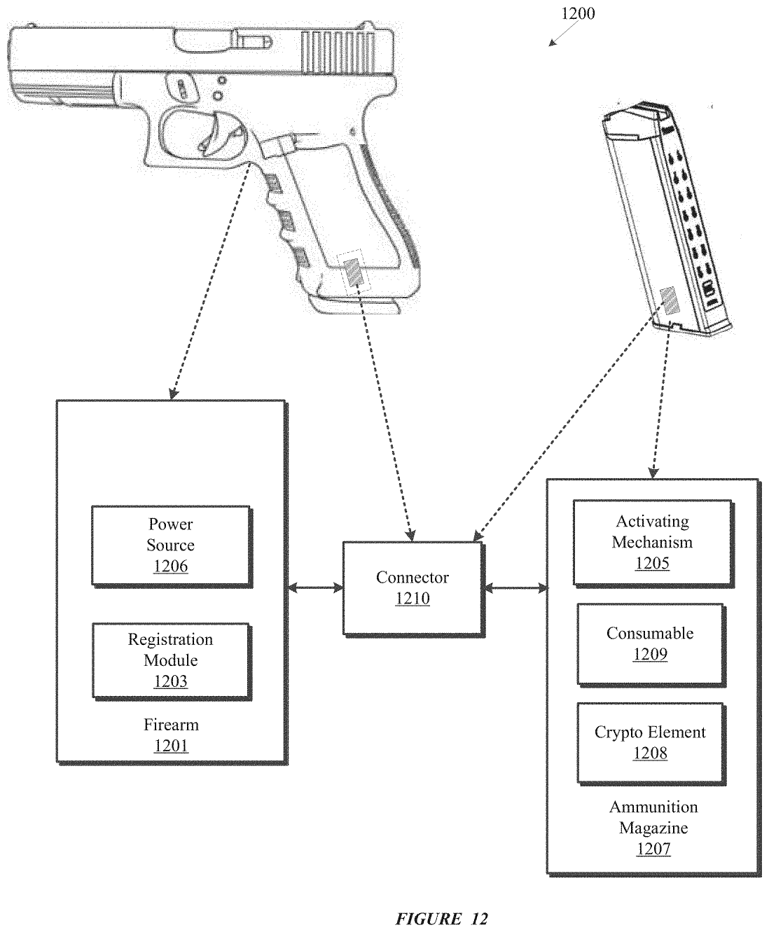

Connector 810 may be configured, generally, to operatively couple cartridge 807 to user device 801. Connector 810 may include interfaces for transferring data and power between cartridge 807 and user device 801, as well as means for activating mechanism 805 to interact with item 809, as more fully described in the examples set forth in FIGS. 12 through 16.

FIG. 12 shows an embodiment of a system 1200 for controlling operation of a magazine 1207 with a firearm 1201, in accordance with disclosed embodiments. In a contemplated operation, a firearm 1201 includes a registration module 1203 that reads an identifier for ammunition magazine 1207 from crypto element 1208 and a power source 1206. Registration module 1203 uses the read identifier to verify operation of firearm 1201 with magazine 1207. If verification is successful, registration module 1203 enables activating mechanism 1205, which, in this example, is part of ammunition magazine 1207. In one embodiment, once enabled, activating mechanism 1205 is configured to advance ammunition, i.e., consumable 1209, in magazine 1207 into the firing chamber of firearm 1201. In various embodiments, enabling activating mechanism 1205 may include, for example, disabling an interference element in connector 1210 (not shown) configured to interfere with normal operation of activating mechanism 1205. An interference element may be, for example, a retractable pin that interferes with a spring system in ammunition magazine 1207.

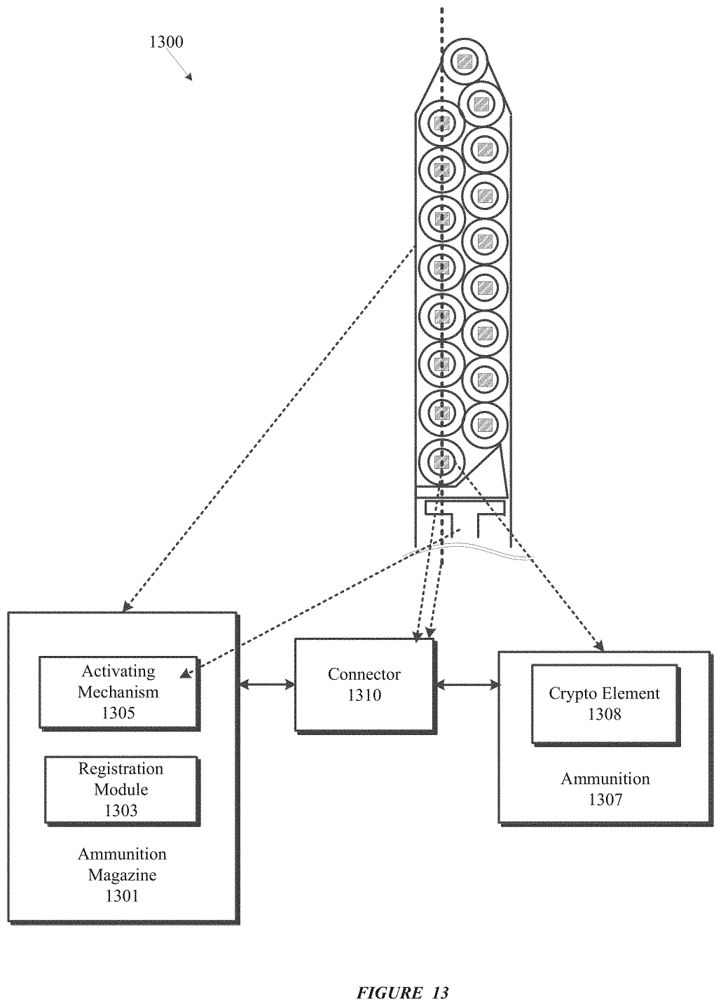

FIG. 13 shows an embodiment of a system 1300 for controlling operation of a magazine 1301 with ammunition 1307, in accordance with disclosed embodiments. In a contemplated operation, magazine 1301 includes a registration module 1303 configured to read identifiers for ammunition 1307 from crypto element 1308 incorporated into each instance of ammunition 1307. Registration module 1303 uses the read identifiers to verify operation of magazine 1301 with ammunition 1307. In one embodiment, if registration module 1303 detects any un-registered ammunition among ammunition 1307, it will not enable activating mechanism 1305. If verification is successful, then registration module 1303 enables activating mechanism 1305. In various embodiments, enabling activating mechanism 1305 may include, for example, disabling an interference elements in connector 1310 (not shown) configured to interfere with normal operation of activating mechanism 1305. An interference element may be, for example, a pin that interferes with a spring system of magazine 1301. Magazine 1301 further comprises a power source (not shown) to provide power for operation of registration module 1303.

In one embodiment, registration module 1303 is incorporated into a firearm, and if ammunition 1307 is not verified then an interference element configured to interfere with a firing mechanism of the firearm remains enabled.

In various embodiments related to controlling use of a firearm with ammunition or a magazine, or a magazine with ammunition a registration module may be configured to enable/disable use, for example, through enabling/disabling a trigger lock, or enabling/disabling a feed ramp or other mechanism for moving ammunition out of a magazine into a firing chamber.

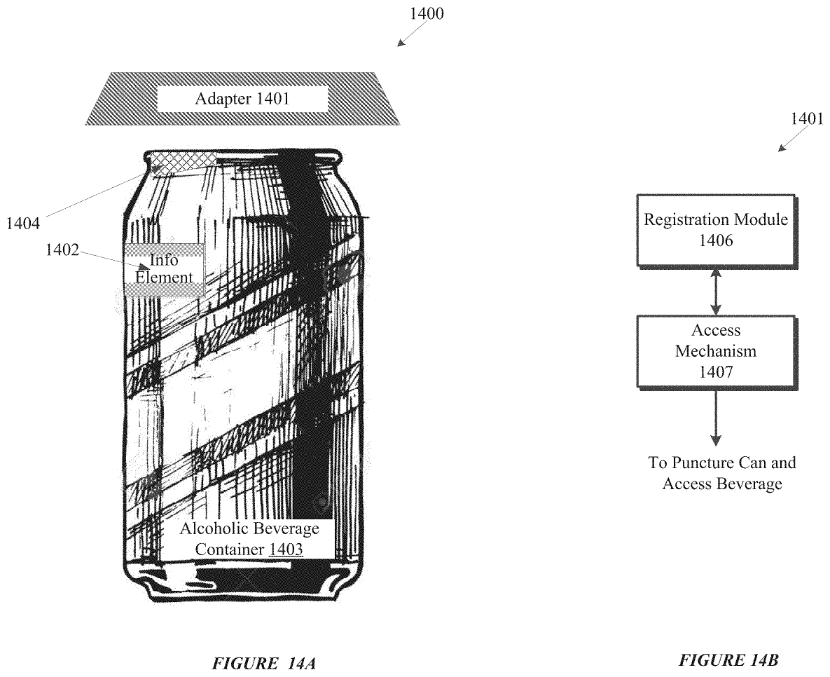

FIGS. 14A and 14B show an embodiment of a system 1400 for controlling operation of an alcoholic beverage container 1403 with an adapter 1401. Adapter 1401 may include a registration module 1406 for verifying operation of adapter 1401 with alcoholic beverage container 1403. In disclosed embodiments, alcoholic beverage container 1403 may or may not include an access element (not shown) for accessing contents of alcoholic beverage container 1403. An access element may be, for example, a stay-tab or pull-tab opening mechanism. Embodiments of adapter 1401 may include a mechanism 1407 or puncturing a beverage container 1403 or activating an access element of alcoholic beverage container 1403 and thereby provide access to the contents of the alcoholic beverage container. Adapter 1401 may be configured to enable/disable such a mechanism responsive to verifying operation of adapter 1401 with alcoholic beverage container 1403.

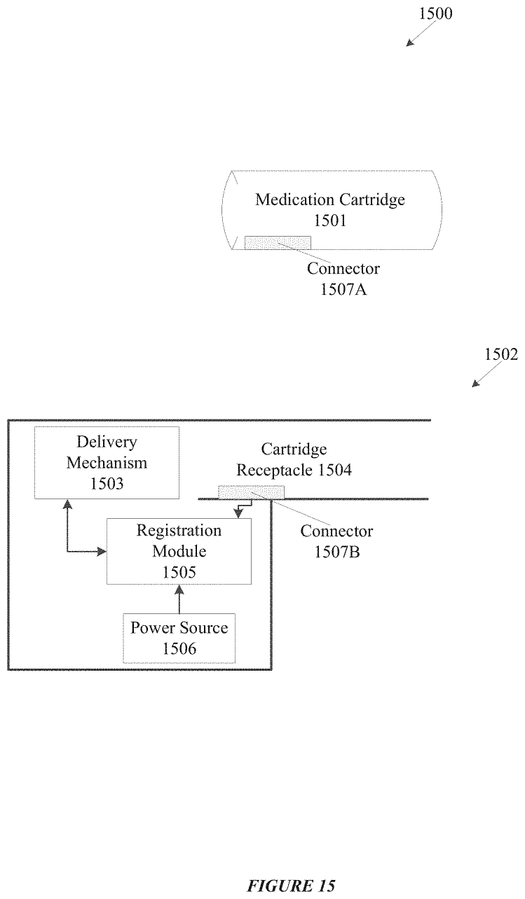

FIG. 15 shows a system 1500 for controlling delivery of medication by a medication delivery device 1502. In disclosed embodiments, system 1500 may be configured to control operation of medication delivery device 1502 with medication cartridge 1501. In one embodiment, medication delivery device 1502 may include a delivery mechanism 1503 configured to cause medication in a cartridge inserted into medication receptacle 1504 to be expelled from medication delivery device 1502. Delivery mechanism 1503 may be, for example, a pump or an infusion pump. Registration module 1505 may be configured to verify operation of medication delivery device 1502 with medication cartridge 1501 in accordance with disclosed embodiments. If verification fails, registration module 1505 may disable (or not enable) operation of delivery mechanism 1503. By way of example, registration module 1505 may instruct a controller (not shown) to turn off, or pause, operation delivery mechanism 1503; or open a circuit operatively coupling power source 1506 to delivery mechanism 1503. When inserted into cartridge receptacle 1504, connector 1507, constituted of connector 1507A mated with connector 1507B, may provide electrical connectivity between medication cartridge 1501 and medication delivery device 1502. More specifically, when connector 1507A of medication cartridge 1501 contacts connector 1507B of medication delivery device 1502, registration module 1505 may retrieve and authenticate medication cartridge information stored at a crypto element (not shown) of medication cartridge 1501.

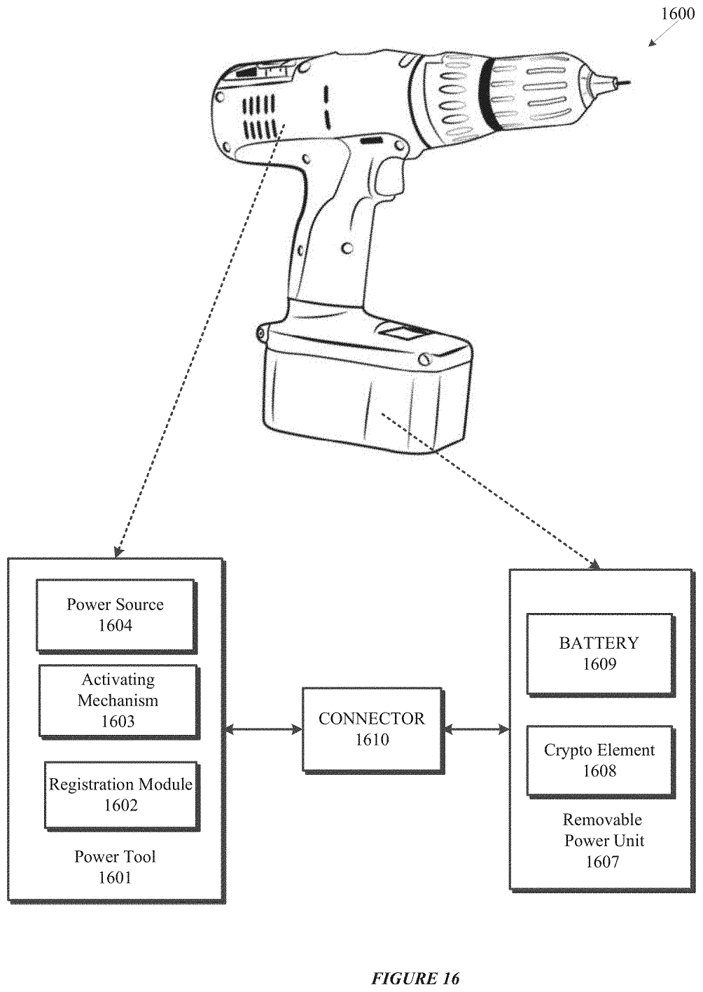

FIG. 16 shows a system 1600 for controlling operation of a power tool 1601 with a removable power unit 1607, in accordance with disclosed embodiments. In one embodiment, removable power unit 1607 is not reusable (e.g., not rechargeable) so the entire removable power unit 1607 is a consumable. In another embodiment, removable power unit 1607 is reusable (e.g., rechargeable) so the stored power is the consumable.

In disclosed embodiments, power tool 1601 includes a registration module 1602 configured to read an identifier for removable power unit 1607 from crypto element 1608 of removable power unit 1607. The operation of registration module 1602 is powered from power source 1604, which may a rechargeable cell, which is charged from removable power unit 1607 after authentication. Registration module 1602 is configured to verify if operation of power tool 1601 with removable power unit 1607 is permitted. If verification fails then registration module 1602 may disable (or not enable) use of removable power unit 1607 with power tool 1601, for example, by not enabling activating mechanism 1603. Power tool 1601 may include modules for communicating with a linking system. When power tool 1601 and removable power unit 1607 are coupled, connector 1610 may provide electrical connectivity such that registration module 1602 may read removable power unit information from crypto element 1608 and/or authentication information from crypto element 1608. Moreover, once operation of removable power unit 1607 with power tool 1601 is verified, connector 1610 may enable power to be provided to activating mechanism 1603 from battery 1609, for example, by closing a switch.

In one embodiment, system 1600 may be implemented to control use of non-OEM rechargeable batteries with a power tool. Power source 1604 may be a power source for registration module 1602 that is separate from removable power unit 1607. In another embodiment, registration module 1602 may receive power from battery 1609 by way of a dedicated circuit and in such an embodiment power source 1604 is not required.

In or more embodiments of the disclosure relate, generally, to providing an anti-counterfeiting system for restricting use of counterfeit devices/products with controlled user devices. For example, counterfeit power and data cables (e.g., for use with smart phones, televisions, and video game systems, without limitation) may be detected and a user alerted that a cable is not from an OEM.

Any characterization in this disclosure of something as “typical,” “conventional,” or “known” does not necessarily mean that it is disclosed in the prior art or that the discussed aspects are appreciated in the prior art. Nor does it necessarily mean that, in the relevant field, it is widely known, well-understood, or routinely used.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor(s).

One or more non-limiting embodiments of the disclosure include:

Embodiment 1: A system, the system comprising: an item; a cartridge configured to hold the item; a user device configured for operable coupling to the cartridge, wherein while operably coupled the cartridge and the user device form a system configured to perform a process that would deplete at least a portion of the item; and a registration module configured to: verify the cartridge was linked to the user device by a linking system; and permit operable coupling of the user device and the cartridge responsive to verifying that the cartridge is linked to the user device.

Embodiment 2: The system according to Embodiment 1, further comprising a communications module configured to establish a communications link with an external device.

Embodiment 3: The system according to any of Embodiments 1 and 2, wherein the external device is a server of the linking system or an intermediate device configured to communicate with the linking system.

Embodiment 4: The system according to any of Embodiments 1 through 3, wherein the registration module is configured to send, via the communications link, a request for identifiers of cartridges linked to the user device to the external device.

Embodiment 5: The system according to any of Embodiments 1 through 4, wherein the registration module is configured to send, via the communications link, a verification request, wherein the verification request includes cartridge information.

Embodiment 6: The system according to any of Embodiments 1 through 5, wherein the registration module is configured to: receive a verification result generated by the linking system, wherein the verification result is an indication that the cartridge is linked to the user device or an indication that the cartridge is not linked to the user device.

Embodiment 7: The system according to any of Embodiments 1 through 6, further comprising an adapter configured to be releasably coupled to the user device or the cartridge, wherein the adapter comprises the registration module and the communication module.

Embodiment 8: The system according to any of Embodiments 1 through 7, wherein the user device comprises a crypto element configured to store authentication information, and wherein the registration module is configured to authenticate the user device responsive to the authentication information.

Embodiment 9: The system according to any of Embodiments 1 through 8, wherein the item is an e-liquid, the cartridge is an e-liquid cartridge, and the user device is a battery unit, and wherein the registration module is configured to permit operable coupling by enabling a transfer of power from the battery unit to a vaporizing element of the e-liquid cartridge.

Embodiment 10: The system according to any of Embodiments 1 through 9, wherein the item is ammunition, the cartridge is a magazine, and the user device is a firearm, and wherein the registration module is configured to enable operation of the magazine to advance ammunition to a chamber of the firearm, thus permitting the operable coupling.

Embodiment 11: The system according to any of Embodiments 1 through 10, wherein the item is medication, the cartridge is a medication cartridge, and the user device is a medication delivery device, and wherein the registration module is configured to enable operation of the medication delivery device to deliver the medication, thus permitting the operable coupling.

Embodiment 12: The system according to any of Embodiments 1 through 11, wherein the item is a battery, the cartridge is a removable power unit, and the user device is a power tool, and wherein the registration module is configured to enable a transfer of power from the battery to the power tool, thus permitting the operable coupling.

Embodiment 13: The system according to any of Embodiments 1 through 12, wherein the communication module is configured for one or more of Internet connectivity and close proximity communication.

Embodiment 14: The system according to any of Embodiments 1 through 13, wherein the external device is an intermediary device.

Embodiment 15: The system according to any of Embodiments 1 through 14, wherein the external device is a remote server.

Embodiment 16: The system according to any of Embodiments 1 through 15, wherein the cartridge comprises a crypto element, wherein the crypto element is configured to store authentication information and the registration module is configured to receive the authentication information and authenticate the cartridge responsive to the authentication information prior to verifying the cartridge is linked to the user device.

Embodiment 17: A method, the method comprising: detecting a coupling of a cartridge to a user device; performing a verification process for verifying operation of the cartridge with the user device, wherein the verification process comprises verifying the cartridge was linked to the user device by a linking system; and operably coupling the cartridge and the user device responsive to the performed verification process, the operably coupled cartridge and user device forming a system configured to perform one or more processes that would deplete at least a portion of an item stored in the cartridge.

Embodiment 18: The method according to Embodiment 17, wherein verifying the cartridge was linked to the user device by the linking system comprises: comparing cartridge information to a list of cartridge identifiers linked to the user device; and determining that the cartridge information corresponds to one of the cartridge identifiers.

Embodiment 19: The method according to any of Embodiments 17 and 18, further comprises: sending a request for verification that the cartridge is permitted to operate with the user device to the linking system; and receiving a verification result generated by the linking system, wherein the verification result indicates that the user device is permitted to operate with the cartridge or indicates that the user device is not permitted to operate with the cartridge.

Embodiment 20: The method according to any of Embodiments 17 through 19, further comprising locally registering the cartridge with the user device to enable the verification process.

Embodiment 21: The method according to any of Embodiments 17 through 20, further comprising authenticating the cartridge before performing the verification process.

Embodiment 22: The method according to any of Embodiments 17 through 21, further comprising authenticating the user device before performing the verification process.

Embodiment 23: The method according to any of Embodiments 17 through 22, further comprising: requesting an electronic identifier from a crypto element of the cartridge; and affixing a machine readable representation of the electronic identifier to an exterior portion of the cartridge or an exterior portion of a packaging for the cartridge.

Embodiment 24: The method according to any of Embodiments 17 through 23, further comprising: obtaining cartridge information of the cartridge responsive to scanning the machine readable representation of the electronic identifier; obtaining purchaser information responsive to scanning an identification card; and sending the purchaser information and the cartridge information to the linking system.

Embodiment 25: The method according to any of Embodiments 17 through 24, further comprising: receiving, at the linking system, the purchaser information and the cartridge information; and linking the cartridge to the purchaser responsive to the purchaser information and the cartridge information.

Embodiment 26: The method according to any of Embodiments 17 through 25, further comprising: obtaining battery unit information responsive to scanning a machine readable representation of an electronic identifier of a battery unit; obtaining purchaser information responsive to scanning an identification card; and sending the purchaser information and the battery unit information to the linking system.

Embodiment 27: The method according to any of Embodiments 17 through 26, further comprising: receiving, at the linking system, the purchaser information and the battery unit information; and linking the battery unit to the purchaser responsive to the purchaser information and the battery unit information.

What is claimed is:

1. A system, the system comprising:
an item;
a cartridge configured to hold the item;
a user device configured for operable coupling to the cartridge, wherein while operably coupled the cartridge and the user device form a system configured to perform a process that would deplete at least a portion of the item; and
a registration module configured to:
verify the cartridge was linked to the user device by a linking system; and
permit operable coupling of the user device and the cartridge responsive to verifying that the cartridge is linked to the user device.

2. The system of claim 1, further comprising a communications module configured to establish a communications link with an external device.

3. The system of claim 2, wherein the external device is a server of the linking system or an intermediate device configured to communicate with the linking system.

4. The system of claim 2, wherein the registration module is configured to send, via the communications link, a request for identifiers of cartridges linked to the user device to the external device.

5. The system of claim 2, wherein the registration module is configured to send, via the communications link, a verification request, wherein the verification request includes cartridge information.

6. The system of claim 5, wherein the registration module is configured to:
receive a verification result generated by the linking system, wherein the verification result is an indication that the cartridge is linked to the user device or an indication that the cartridge is not linked to the user device.

7. The system of claim 2, further comprising an adapter configured to be releasably coupled to the user device or the cartridge, wherein the adapter comprises the registration module and the communication module.

8. The system of claim 7, wherein the user device comprises a crypto element configured to store authentication information, and wherein the registration module is configured to authenticate the user device responsive to the authentication information.

9. The system of claim 1, wherein the item is an e-liquid, the cartridge is an e-liquid cartridge, and the user device is a battery unit, and wherein the registration module is configured to permit operable coupling by enabling a transfer of power from the battery unit to a vaporizing element of the e-liquid cartridge.

10. The system of claim 1, wherein the item is ammunition, the cartridge is a magazine, and the user device is a firearm, and wherein the registration module is configured to enable operation of the magazine to advance ammunition to a chamber of the firearm, thus permitting the operable coupling.

11. The system of claim 1, wherein the item is medication, the cartridge is a medication cartridge, and the user device is a medication delivery device, and wherein the registration module is configured to enable operation of the medication delivery device to deliver the medication, thus permitting the operable coupling.

12. The system of claim 1, wherein the item is a battery, the cartridge is a removable power unit, and the user device is a power tool, and wherein the registration module is configured to enable a transfer of power from the battery to the power tool, thus permitting the operable coupling.

13. The system of claim 2, wherein the communication module is configured for one or more of Internet connectivity and close proximity communication.

14. The system of claim 1, wherein the external device is an intermediary device.

15. The system of claim 1, wherein the external device is a remote server.

16. The system of claim 1, wherein the cartridge comprises a crypto element, wherein the crypto element is configured to store authentication information and the registration module is configured to receive the authentication information and authenticate the cartridge responsive to the authentication information prior to verifying the cartridge is linked to the user device.

17. A method, the method comprising:
detecting a coupling of a cartridge to a user device;
performing a verification process for verifying operation of the cartridge with the user device, wherein the verification process comprises verifying the cartridge was linked to the user device by a linking system; and
operably coupling the cartridge and the user device responsive to the performed verification process, the operably coupled cartridge and user device forming a system configured to perform one or more processes that would deplete at least a portion of an item stored in the cartridge.

18. The method of claim 17, wherein verifying the cartridge was linked to the user device by the linking system comprises:
comparing cartridge information to a list of cartridge identifiers linked to the user device; and
determining that the cartridge information corresponds to one of the cartridge identifiers.

19. The method of claim 17, further comprises:
sending a request for verification that the cartridge is permitted to operate with the user device to the linking system; and
receiving a verification result generated by the linking system, wherein the verification result indicates that the user device is permitted to operate with the cartridge or indicates that the user device is not permitted to operate with the cartridge.

20. The method of claim 17, further comprising locally registering the cartridge with the user device to enable the verification process.

21. The method of claim 17, further comprising authenticating the cartridge before performing the verification process.

22. The method of claim 17, further comprising authenticating the user device before performing the verification process.

23. The method of claim 17, further comprising:
requesting an electronic identifier from a crypto element of the cartridge; and
affixing a machine readable representation of the electronic identifier to an exterior portion of the cartridge or an exterior portion of a packaging for the cartridge.

24. The method of claim 23, further comprising:
obtaining cartridge information of the cartridge responsive to scanning the machine readable representation of the electronic identifier;
obtaining purchaser information responsive to scanning an identification card; and
sending the purchaser information and the cartridge information to the linking system.

25. The method of claim 24, further comprising:
receiving, at the linking system, the purchaser information and the cartridge information; and
linking the cartridge to the purchaser responsive to the purchaser information and the cartridge information.

26. The method of claim 17, further comprising:
obtaining battery unit information responsive to scanning a machine readable representation of an electronic identifier of a battery unit;
obtaining purchaser information responsive to scanning an identification card; and
sending the purchaser information and the battery unit information to the linking system.

27. The method of claim 26, further comprising:
receiving, at the linking system, the purchaser information and the battery unit information; and
linking the battery unit to the purchaser responsive to the purchaser information and the battery unit information.
